(19) United States
(12) Patent Application Publication
(10) Pub. No.: US 2013/0170891 A1
(43) Pub. Date: Jul. 4, 2013

(54) Magnetic-Mechanical Connection Assembly and Writing Instrument Comprising Same

(71) Applicants: DAVID MARTIN, GLYNDE NR LEWES (GB); LEIGHTON DAVIES-SMITH, Founex (CH)

(72) Inventors: DAVID MARTIN, GLYNDE NR LEWES (GB); LEIGHTON DAVIES-SMITH, Founex (CH)

(73) Assignee: PARKER PEN PRODUCTS, EAST SUSSEX (GB)

(21) Appl. No.: 13/340,083

(22) Filed: Dec. 29, 2011

(51) Int. Cl. B43K 23/12

(52) U.S. Cl. 401/244

(57) ABSTRACT

A writing instrument includes a nose section that is connected to a barrel housing portion that contains an ink reservoir for holding ink for delivery to a writing nib. A cap may be releasably secured to the nose section with a magnetic-mechanical connection assembly to cover the nib to protect the nib from damage and to prevent ink evaporation.

### BACKGROUND

1. Field of the Invention

The invention generally relates to a writing instrument with a magnetic-mechanical connection assembly and more specifically to a writing instrument having a magnetic-mechanical connection assembly releasably securing a cap to a nose section of a barrel.

2. Related Technology

Conventional writing instruments typically have a cap or cover of some sort that protects the writing nib and helps to prevent ink from evaporating from the nib when the writing instrument is not being used. Often the cap is a separate component that is releasably secured to a nose section of a barrel of the writing instrument.

Generally, known writing instruments use one of two different connection mechanisms to releasably secure the cap to the nose section.

First, some known writing instruments use a threaded connection where the cap is screwed onto the nose section. This type of threaded connection, while being secure, can be somewhat cumbersome for a consumer to use. Initially, the consumer must align the cap with the nose section and then the cap must be rotated through several revolutions to a secured position. The reverse operation is needed to remove the cap from the nose section. This threaded connection is therefore somewhat time consuming and inefficient to use, especially when the cap needs to be secured and removed from the nose section repeatedly in a short period of time. Additionally, the threaded connection can easily become damaged if the threads are improperly aligned prior to and/or during rotation.

A second type of connection is an interference connection that uses offset ridges, usually a first ridge on the outside of the nose section and a second ridge on the inside of the cap. A consumer aligns the cap and the nose section and pushes the cap until the second ridge slides over the first ridge to provide a secured position between the cap and the nose section. This type of connection is often called a “snap-fit” connection. While this type of connection is quicker to use, it is also more susceptible to inadvertent dislodgement as it is inherently weaker than the threaded connection. Additionally, this type of connection is more prone to weakening (due to material loss from repeated frictional engagement) or warping over time.

### SUMMARY

An instrument comprises a nose section having a hollow channel and a first opening at one end of the hollow channel. A barrel housing portion has an interior, the nose section being at least partially disposed within the interior of the barrel housing portion. A cap is releasably attached to the nose section to enclose the opening. A magnetic-mechanical connection assembly between the cap and the nose section provides magnetic and mechanical force to secure the cap to the nose portion, the magnetic-mechanical connection assembly including at least one bayonet pin disposed on one of the cap and the nose section and at least one locking channel disposed on the other of the cap and the nose section.

A writing instrument comprises a nose section having an opening at one end. A writing nib extends through the opening. A barrel housing portion is connected to the nose section opposite of the writing nib, the barrel housing portion having an ink reservoir for holding ink to be delivered to the writing nib. A cap is releasably connected to the nose section, the cap protecting the nib from damage. A magnetic-mechanical connection assembly provides connection force for releasably connecting the cap to the nose section. The magnetic-mechanical connection assembly includes at least one nose magnet disposed on the nose section, at least one cap magnet disposed on the cap, at least one locking channel formed in an inner surface of the cap, and at least one bayonet pin formed on an outer surface of the nose section, the bayonet pin being sized and shaped to fit within the locking channel to mechanically secure the cap to the nose section, such that the barrel housing magnet and the nose magnet are aligned to provide an attractive force therebetween.

### BRIEF DESCRIPTION OF THE DRAWINGS

Further features and advantages of the invention can be gathered from the claims, the following description, and the attached diagrammatic drawings, wherein:

FIG. 1 is a perspective view of a first embodiment of a writing instrument having a magnetic-mechanical connection assembly between a cap and a nose portion of a barrel;

FIG. 2 is a close-up perspective view of the magnetic-mechanical connection assembly of FIG. 1 in an assembled position;

FIG. 3 is a schematic view of several magnets that may be used in the magnetic-mechanical connection assembly of FIG. 2 when assembled and the components are rotated into a locked position;

FIG. 4 is a schematic view of several magnets that may be used in an alternate embodiment of the magnetic-mechanical connection assembly of FIG. 2 when assembled and the components are rotated into a locked position;

FIG. 5 is a plan view of a ring magnet that may be used in the magnetic-mechanical connection assembly if FIG. 2;

FIGS. 6 and 7 are perspective views of two ring magnets illustrated in FIG. 5, the two ring magnets being in various orientations with respect to one another generally illustrating the repelling and attractive forces generated during rotation; and

FIG. 8 is a perspective view of a second embodiment of a writing instrument having a magnetic-mechanical connection assembly between the cap and the nose section of the barrel.

### DETAILED DESCRIPTION

The disclosed writing instrument advantageously includes a magnetic-mechanical connection assembly between a cap and a nose section of a barrel, the magnetic-mechanical connection assembly having an opening force that is greater than the magnetic force generated between magnets alone in the magnetic-mechanical connection assembly because a mechanical interaction must also be overcome. The writing instrument relies on magnetic field attraction for a motive force to pull or twist the cap into a secured position with respect to the nose section. The magnetic field attraction also provides continuing motive force to maintain the cap in the secured position. This magnetic field attraction must be overcome by a consumer to release the cap from the nose section. Thus writing instrument described herein advantageously provides a consumer with a closure system that includes a quick-release connection having a tactile sensation that indicates a secured position. The quick-release connection allows a cap to be quickly secured to, or released from, the nose section.

A fountain pen 10 is exemplified in the drawings, however, other writing instruments including, but not limited to markers, highlighters, ball pens, felt tip pens, and other fluid application devices including, but not limited to, correction fluid applicators and paint applicators could also be made in accordance with the teachings of the disclosure by selection of appropriate components. Similarly, other types of tools such as utility blades, screw drivers, punches, flashlights, etc., may be constructed in accordance with the teachings of the disclosure by substituting a tool for the illustrated writing nib.

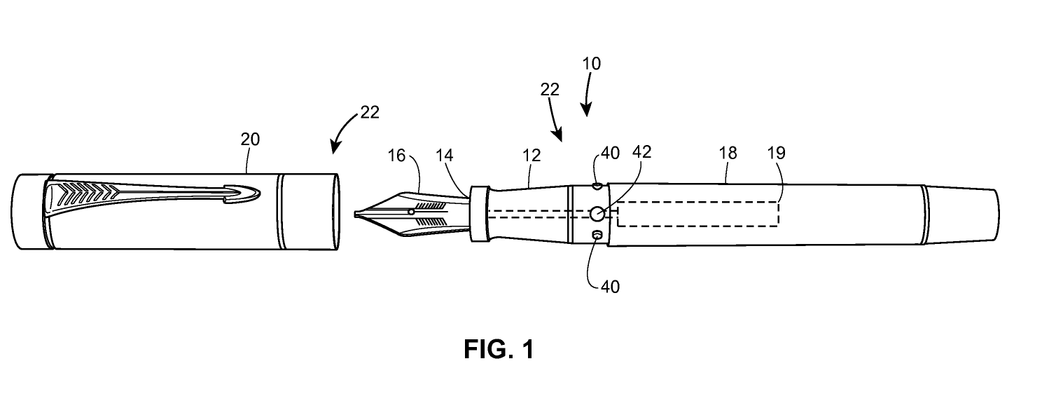

Turning now to FIG. 1, the fountain pen 10 comprises nose section 12 of a barrel 21, the nose section 12 having an opening 14 at one end thereof through which a writing nib 16 extends. The nose section 12 is connected to a barrel housing portion 18, which houses an ink reservoir 19 that is capable of holding a supply of ink for delivery to the writing nib 16 (i.e., the ink reservoir can be in fluid communication with the nib when the cap 20 and the nose section 12 are assembled). A cap 20 may be releasably connected to the nose section 12 to cover the nib 16 when the nib 16 is not being used, so as to prevent ink from evaporating from the nib 16 and/or to prevent the nib 16 from becoming damaged. The cap 20 and nose section 12 include a magnetic-mechanical connection assembly 22 that releasably secures the cap 20 to the nose section 12, which facilitates and provides easy access to the writing nib 16.

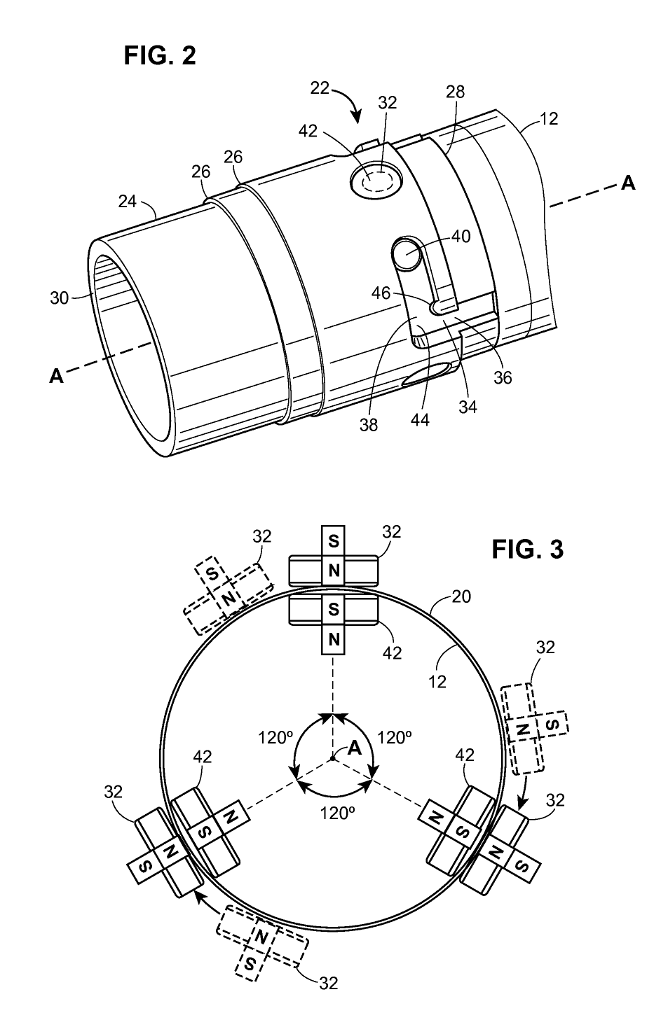

Turning now to FIG. 2, the magnetic-mechanical connection assembly 22 is illustrated in further detail. FIG. 2 illustrates one end of the cap 20 in an attached position relative to one end of the nose section 12 proximate the opening 14. The cap 20 may include a cap connection portion 24 having one or more steps 26 having an increased diameter relative to a second end 30, with a first end 28 of the cap connection portion 24 being large enough to fit over at least a portion of the nose section 12. The second end 30 of the cap connection portion 24 may fit within a body of the cap 20. In other embodiments, the cap connection portion 24 may be integrally formed with a body of the cap 20 to produce a single, unitary cap structure as long as the unitary cap structure includes the bayonet pins or the locking channels described below. The cap 20 may include one or more cap magnets 32 disposed around an inner periphery of the first end 28 of the cap connection portion 24. The cap magnets 32 may be disposed on an inner cap surface or the cap magnets 32 may be embedded within a wall of the cap connection portion 24. One or more cams or locking channels 34 may be formed in an inner surface of the cap connection portion 24, proximate the first end 28. The one or more locking channels 34 may include a first portion 36 that is substantially parallel to a longitudinal axis A of the cap connection portion 24 and a second portion 38 that is substantially perpendicular to the first portion 36. The first portion 36 and the second portion 38 may form a substantially L-shaped channel, of course other shapes may be used as well. The one or more locking channels 34 may extend completely through a thickness of the cap connection portion 24, as illustrated in FIG. 2. In other embodiments, the one or more locking channels 34 not extend completely through the cap connection portion 24, but rather the locking channels 34 may only extend partially through a thickness of the cap connection portion 24.

The nose section 12 may include one or more bayonet pins 40 disposed about a periphery of the nose section 12. The bayonet pins 40 may have a generally cylindrical shape, extending outward from an outer surface of the nose section 12, as illustrated in FIG. 2. In other embodiments, the bayonet pins 40 may have other shapes, such as rectangular, square, oval, polygon, etc. Regardless, the bayonet pins 40 are sized and shaped to fit into, and slide within, the locking channels 34. The nose section 12 may also include one or more nose magnets 42 disposed about a periphery of the nose section 12 and interspaced with the bayonet pins 40. The nose magnets 42 may have a magnetic polarity that is complimentary to a magnetic polarity of the cap magnets 32 so that the nose magnets 42 and the cap magnets 32 are magnetically attracted to one another. For example, the nose magnets 42 may have a north pole oriented towards a south pole of a cap magnet 32, or vice versa.

The cap 20 is secured to the nose section 12 by aligning the bayonet pins 40 with the first portion 36 of the locking channels 34. As the cap 20 is pushed in a direction substantially parallel to the longitudinal axis A of the cap connection portion 24, the bayonet pins 40 slide within the first portion 36 of the locking channel until the bayonet pins 40 are located at the junction 44 of the first portion 36 and the second portion 38. Once the bayonet pins 40 are aligned with the second portion 38, the magnetic attraction between the cap magnets 32 and the nose magnets 42 produces a twisting force that causes the cap to twist into the position illustrated in FIG. 2 in which the cap magnets 32 and the nose magnets 42 are generally aligned with one another radially and the bayonet pins 40 are seated at one end of the second portion 38 of the locking channel 34. After the cap magnets 32 and the nose magnets 42 are aligned, the cap 20 is mechanically secured to the nose section 12 with the bayonet pins 40 being disposed within the locking channels 34. A lip 46 may be positioned within the locking channel 34, proximate the junction 44 to prevent the bayonet pin 40 from being inadvertently slid out of the locking channel 34. Advantageously, a consumer receives a tactile indication that the cap 20 is secured on the nose section 12 from the twisting force generated by the interaction between the cap magnets 32 and the nose magnets 42.

FIG. 3 schematically illustrates relative positioning between the cap magnets 32 and the nose magnets 42 as the cap 20 is secured to the nose section 12. Initially, the cap magnets 32 are not aligned with the nose magnets 42, the initial position of the cap magnets 32 is represented by the cap magnets 32 illustrated in phantom. Once the bayonet pins 40 are aligned with the second portion 38 of the locking channel 34, the magnetic attraction between the cap magnets 32 and the nose magnets 42 produces a twisting force that rotates the cap 20 relative to the nose section 12. Once the cap magnets 32 and the nose magnets 42 are aligned radially and disposed adjacent to one another, as illustrated by the cap magnets 32 in solid lines in FIG. 3, the bayonet pins 40 and locking channels 34 mechanically secure the cap 20 to the nose section 12, as described above. As illustrated in FIG. 3, the cap magnets 32 and the nose magnets 42 may take the form of disc magnets having a north pole and a south pole. The cap magnets 32 may have their magnetic fields oriented in a complimentary direction to the magnetic fields of the nose magnets 42 so that the cap magnets 32 and the nose magnets 42 are magnetically attracted to one another. For example, the cap magnets 32 may have a south pole oriented radially outward and a north pole oriented radially inward. Likewise, the nose magnets 42 may have a south pole oriented radially outward and a north pole oriented radially inward, as illustrated in FIG. 3. In other embodiments, the cap magnets 32 and the nose magnets 42 may have a north pole oriented radially outward and a south pole oriented radially inward, essentially opposite of the orientations illustrated in FIG. 3. In yet other embodiments, the cap magnets 32 and the nose magnets 42 may have varying orientations as long as radially adjacent magnets (when aligned upon securing the respective components to one another) have complimentary orientations when the cap 20 is in a secured position with the bayonet pins 40 seated in the second portion 38 of the locking channel 34. Removal of the cap 20 may be accomplished opposite of attachment of the cap 20 described above.

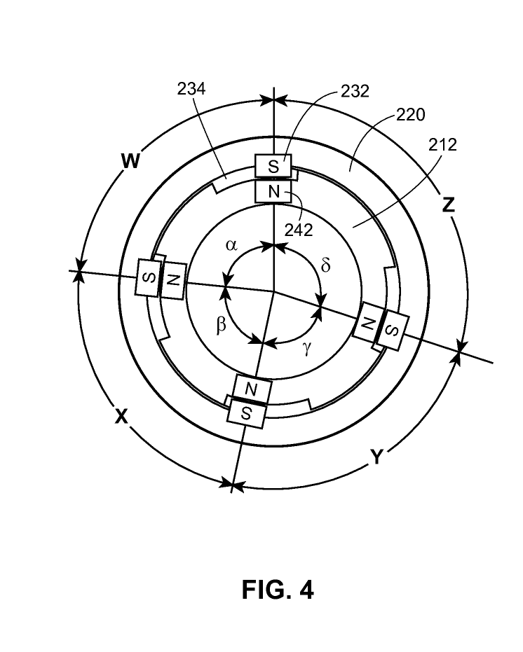

In one embodiment, the nose 12 may include three nose magnets 42 and three bayonet pins 40. The three nose magnets 42 may be spaced about a periphery of the nose section 12 and separated from one another by approximately 120 degrees. Similarly, the three bayonet pins 40 may be spaced about the periphery of the nose section 12 and separated from one another by approximately 120 degrees. In other embodiments other combinations of nose magnets 42 and/or bayonet pins 40 may be used. For example, other embodiments may include two, four, five, six, or more of nose magnets 42 or bayonet pins 40, or any combination thereof. In yet other embodiments, the nose magnets 42 and bayonet pins 40 may be spaced at irregular intervals about a periphery of the barrel, as further discussed with reference to FIG. 4. In yet other embodiments, the nose magnets 42 may be embedded within the nose section 12 as long as the magnetic field generated by the nose magnets 42 is sufficient to produce a twisting force when interacting with the cap magnets 32.

In other embodiments, the bayonet pins 40 and the locking channels 34 may be reversed (e.g., the bayonet pins 40 may be located on an inner surface of the cap 20 and the locking channels 34 may be located on an outer surface of the nose section 12).

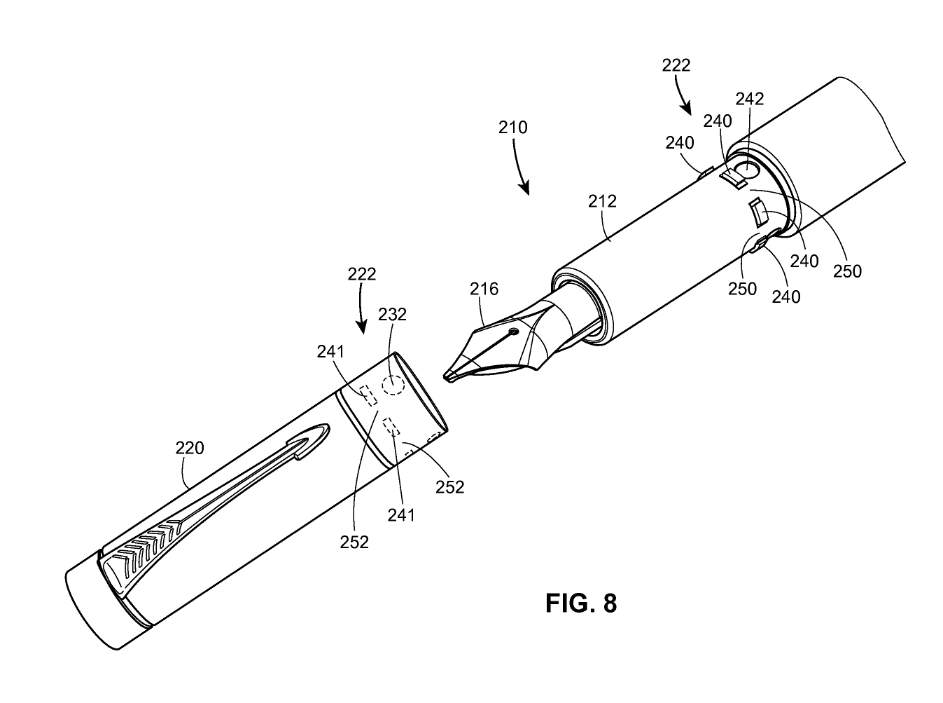

In another embodiment of a writing instrument 210, illustrated in FIG. 8, the magnetic-mechanical connection assembly 222 may include a plurality of nose projections or nose lugs 240 disposed about a periphery of the nose section 212. A nose space 250 is formed between each of the nose lugs 240 resulting in a plurality of nose spaces 250 being disposed about a periphery of the nose section 212. The nose section 212 may also include one or more nose magnets 242.

The cap 220 may include a plurality of cap projections or cap lugs 241 disposed circumferentially about an inner surface of the cap 220. A cap space 252 may be disposed between each of the cap lugs 241 resulting in a plurality of cap spaces 252 being disposed circumferentially about an inner surface of the cap 220. The cap 220 may also include one or more cap magnets 232.

To secure the cap 220 to the nose section 212, the cap lugs 241 are generally aligned with the nose spaces 250. As the cap 220 moves along a longitudinal axis of the nose section 212, the cap lugs 241 pass between the nose lugs 240 through the nose spaces 250. Once the nose lugs 240 are located beyond the cap lugs 241 such that the cap lugs 241 are located between the nose lugs 240 and the nib 216, magnetic attraction between the nose magnets 242 and the cap magnets 232 creates a twisting force that rotates the cap 220 relative to the nose section 212 until the cap magnets 232 and the nose magnets 242 are substantially radially aligned and adjacent to one another. Similarly, the nose lugs 240 and the cap lugs 241 will also be generally longitudinally aligned with one another, which helps prevent the cap 220 from being inadvertently removed from the nose section 212.

FIG. 4 schematically illustrates an alternative relative positioning between the cap magnets 232 and the nose magnets 242 when the cap 220 is secured to the nose section 212. In contrast to the embodiment illustrated in FIGS. 1 and 2, the locking channels 234 are formed in the nose section 212 of the embodiment illustrated in FIG. 4. Moreover, the cap magnets 232 may be formed as posts or pins to serve the function of the bayonet pins of the embodiment of FIGS. 1 and 2. The cap 220 is illustrated in FIG. 4 with the cap magnets 232 being seated in the locking channel 234. In this embodiment, the there are four cap magnets 232 and four nose magnets 242. For ease of reference, the cap magnets 232 and the nose magnets 242 are illustrated with only a single pole. However, both the cap magnets 232 and the nose magnets 242 are bi-polar. The cap magnets 232 and the nose magnets 242 may not be spaced equidistantly around an inner surface of the cap 220 and an outer periphery of the nose section 12, respectively. For example, while distances W, X, and Y may be substantially equal, distance Z may be larger than any of distances W, X, and Y Likewise, angular orientations may not be equal between each of the barrel magnets 242 and between each of the cap magnets 232. For example, three angles α, β, and γ may be substantially equal (e.g., approximately 85 degrees) while angle δ may be larger than angles α, β, and γ (e.g., approximately 105 degrees). This unequal spacing of the nose magnets 242 and the cap magnets 232 provides a single radial locking position between the cap 220 and the nose section 212. In other words, there is only one radial position that will allow cap 220 to be secured to the nose section 212. This single radial position may be beneficial to align graphics or other features on the nose section 212 with graphics or other features on the cap 220.

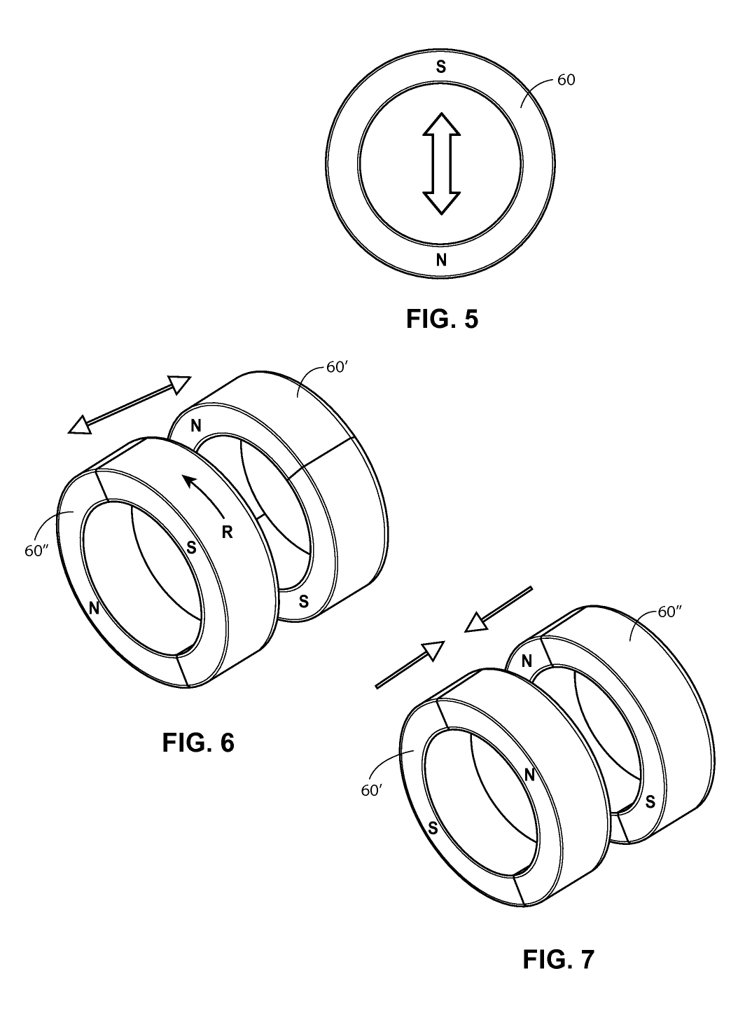

FIGS. 5-7 illustrate one embodiment of polarized ring magnets 60 that may be used for any of the cap magnets 32 and/or the nose magnets 42 of the previous embodiments. The polarized ring magnets 60 may be formed as a ring of magnetic material having a north pole opposite a south pole. When two ring magnets 60′, 60″ are located adjacent one another, as when the cap 20 is being attached to the nose section 12, the first ring magnet 60′ initially has the north and south poles offset with respect to the north and south poles of the second ring magnet 60″, as illustrated in FIG. 6. The orientation in FIG. 6 corresponds to a position of the a position of the cap 20 in which the bayonet pins 40 are generally aligned with the first portion 36 of the locking channel 34. A repulsive force is produced because there is more overlap between the north poles of the first and second ring magnets 60′, 60″ (likewise for south poles of the two magnets) than there is overlap between respective north and south poles (which creates an attractive force). This repulsive force gives a consumer a non-visual (e.g., a tactile) indication that the cap 20 is properly aligned with the nose section 12.

As the second ring magnet 60″ is rotated in the direction of R (FIG. 6), the north pole of the second ring magnet 60″ gradually becomes aligned with the south pole of the first ring magnet 60′, causing the repulsive force to gradually decrease, and eventually change to a net attractive force that results in twisting of the cap 20 relative to the nose section 12. This net attractive force gives a consumer a non-visual (e.g., a tactile) indication that the cap 20 is approaching a fully seated (i.e., a secured) position on the nose section 12. Moreover, this net attractive force maintains the cap 20 in the secured position, which reduces the possibility of the cap 20 becoming inadvertently dislodged.

Any suitable magnet may be used to provide the cap magnets 32 and/or the nose magnets 42. In one embodiment the cap magnets 32 and/or the nose magnets 42 may comprise neodymium iron boron disc super magnets having a field strength of approximately 400 g. In other embodiments, various combinations of disc magnets may be arranged to produce an initial repulsive force followed by a twist-attraction, as described above.

In yet other embodiments, the cap magnets 32 and/or the nose magnets 42 may comprise diametrically polarized ring super magnets, which can produce either a repulsive or attractive force when a pair of such magnets are brought together depending on relative orientations of the respective north and south poles, as discussed above. Of course, other magnets can also be positioned to produce a repulsive force when the cap 20 is properly aligned with the nose section 12, which transitions to a net attractive force that results in twisting of the cap 20 relative to the nose section 12.

In yet other embodiments the cap magnets 32 and/or the nose magnets 42 may comprise a magnetic plastic resin. For example, the plastic resin can be infused with magnetic material and then subjected to a magnetic field before the resin sets in order to orient particles of the magnetic material in the same direction, thereby imparting magnetic properties to the plastic resin.

In the disclosed embodiments, the magnetic attractions are used to provide a seating force; however, the magnetic attractions are not solely relied upon for a connecting force between cap and nose section, but rather a mechanical interaction provides a significant portion of the connecting force so that the overall connecting force is greater than the magnetic force alone.

The disclosure is not limited to a fountain pen. The disclosure could be applied to virtually any writing instrument or tool, such as utility blades, flashlights, screw drivers, or other similar instruments. The features of the invention disclosed in the description, drawings and claims can be individually or in various combinations for the implementation of the different embodiments of the invention.

1. An instrument comprising:
a nose section having a hollow channel and a first opening at one end of the hollow channel;
a barrel housing portion having an interior, the nose section being at least partially disposed within the interior of the barrel housing portion;
a cap releasably attached to the nose section to enclose the opening; and
a magnetic-mechanical connection assembly between the cap and the nose section that provides magnetic and mechanical force to secure the cap to the nose portion, the magnetic-mechanical connection assembly including at least one bayonet pin disposed on one of the cap and the nose section and at least one locking channel disposed on the other of the cap and the nose section.

2. The instrument of claim 1 wherein the magnetic-mechanical connection assembly includes a plurality of nose magnets disposed about a periphery of the nose section.

3. The instrument of claim 2, wherein the magnetic-mechanical connection assembly includes a plurality of nose bayonet pins disposed about an outer periphery of the nose section.

4. The instrument of claim 3 wherein at least one nose magnet is integrally formed with at least one nose bayonet pin.

5. The instrument of claim 3, wherein the plurality of nose bayonet pins are spaced equidistantly from one another.

6. The instrument of claim 2, wherein the plurality of nose magnets are spaced equidistantly from one another.

7. The instrument of claim 6, wherein the plurality of nose magnets includes three nose magnets, each nose magnet being separated radially by approximately 120 degrees from the other nose magnets.

8. The instrument of claim 1, wherein the magnetic-mechanical connection assembly includes a plurality of cap magnets disposed about an inner surface of the cap.

9. The instrument of claim 1, wherein the magnetic-mechanical connection assembly includes a plurality of cap lugs disposed about an inner surface of the cap.

10. The instrument of claim 1, wherein the magnetic-mechanical connection assembly includes a plurality of locking channels disposed about an inner surface of the cap.

11. The instrument of claim 1, wherein the magnetic-mechanical connection assembly includes a plurality of locking channels disposed about an outer surface of the nose section.

12. The instrument of claim 10, wherein at least one locking channel includes a first portion that is substantially parallel to a longitudinal axis of the nose section and a second portion that is substantially perpendicular to the first portion.

13. The instrument of claim 10, wherein the at least one locking channel includes a lip.

14. The instrument of claim 1, wherein the magnetic-mechanical connection assembly includes at least one ring magnet.

15. The instrument of claim 1, wherein the magnetic-mechanical connection includes a plurality of cap lugs disposed about an inner surface of the cap and a plurality of nose lugs disposed about an outer periphery of the nose section.

16. The instrument of claim 15, wherein the plurality of cap lugs are separated from one another by a plurality of cap spaces and the plurality of nose lugs are separated from one another by a plurality of nose spaces, each of the cap lugs being sized and shaped to fit within one of the nose spaces.

17. A writing instrument comprising:
a nose section having an opening at one end;
a writing nib extending through the opening;
a barrel housing portion connected to the nose section opposite of the writing nib, the barrel housing portion having an ink reservoir for holding ink to be delivered to the writing nib;
a cap releasably connected to the nose section, the cap protecting the nib from damage; and
a magnetic-mechanical connection assembly that provides connection force for releasably connecting the cap to the nose section;
wherein the magnetic-mechanical connection assembly includes at least one nose magnet disposed on the nose section, at least one cap magnet disposed on the cap, at least one locking channel formed in an inner surface of the cap, and at least one bayonet pin formed on an outer surface of the nose section, the bayonet pin being sized and shaped to fit within the locking channel to mechanically secure the cap to the nose section, such that the barrel housing magnet and the nose magnet are aligned to provide an attractive force therebetween.

18. The writing instrument of claim 17, wherein the cap magnet is a ring magnet.

19. The writing instrument of claim 17, wherein the nose magnet is a ring magnet.

20. The writing instrument of claim 17, wherein the cap magnet and the nose magnet interact to produce an initial repelling force when the at least one bayonet pin is aligned with a first portion of the at least one locking channel and the at least one cap magnet and the at least one nose magnet interact to produce an attractive force when the bayonet pin is seated within a second portion of the at least one locking channel.

21. The writing instrument of claim 17, further comprising a lip within the locking channel.

22. The writing instrument of claim 17, wherein one of the at least one cap magnet and the at least one nose magnet is formed from a magnetic plastic material.
